(19) United States
(12) Patent Application Publication
(10) Pub. No.: US 2024/0064263 A1
(43) Pub. Date: Feb. 22, 2024

(54) INFORMATION PROCESSING DEVICE AND METHOD, IMAGE FORMING APPARATUS, AND NON-TRANSITORY COMPUTER READABLE MEDIUM

(71) Applicant: FUJIFILM BUSINESS INNOVATION CORP., Tokyo (JP)

(72) Inventor: Satoshi WATANABE, Kanagawa (JP)

(73) Assignee: FUJIFILM BUSINESS INNOVATION CORP., Tokyo (JP)

(21) Appl. No.: 18/187,772

(22) Filed: Mar. 22, 2023

(30) Foreign Application Priority Data
Aug. 16, 2022 (JP) 2022-129583

(51) Int. Cl. H04N 1/60

(52) U.S. Cl. CPC H04N 1/6072; H04N 2201/0082

(57) ABSTRACT

An information processing device includes at least one processor configured to: replace, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and output the print data reflecting the color of the figure replaced by the spot color.

### CROSS-REFERENCE TO RELATED APPLICATIONS

This application is based on and claims priority under 35 USC 119 from Japanese Patent Application No. 2022-129583 filed Aug. 16, 2022.

### BACKGROUND

### (i) Technical Field

The present disclosure relates to an information processing device and method, an image forming apparatus, and a non-transitory computer readable medium.

### (ii) Related Art

Japanese Patent No. 5361222 discloses a method for performing overlay printing of a form and data by using a spot-color recording agent for a region within the form. The method includes: a spot-color recording agent setting step of setting a setting for using a spot-color recording agent for a region within the form when the form is printed by using the spot-color recording agent for the region within the form; and a determining step of determining whether the region within the form is a region for which text data is to be printed. The method also includes: a spot-color recording agent adding step of adding the spot-color recording agent for the region within the form in accordance with the setting set in the spot-color recording agent setting step if it is determined in the determining step that the region within the form is a region for which text data is to be printed; and a spot-color recording agent setting canceling step of canceling the setting set in the spot-color recording agent setting step if it is determined in the determining step that the region within the form is not a region for which text data is to be printed.

### SUMMARY

A form in which a region to be printed with a spot color is specified may be registered in advance. In this approach, however, it is necessary to prepare a form, and for print data to which a form is not applicable, it is necessary to register a form every time spot color printing is performed.

Aspects of non-limiting embodiments of the present disclosure relate to providing an information processing device and method, an image forming apparatus, and a non-transitory computer readable medium that make it possible to perform spot color printing without registering a form even for image data to which a form is not applicable.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including at least one processor configured to: replace, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and output the print data reflecting the color of the figure replaced by the spot color.

### BRIEF DESCRIPTION OF THE DRAWINGS

Exemplary embodiments of the present disclosure will be described in detail based on the following figures, wherein:

FIG. 1 is a schematic diagram of an information processing system including a user terminal of a first exemplary embodiment;

FIG. 2 is a block diagram of the hardware configuration of the user terminal;

FIG. 3 is a block diagram illustrating an example of the functional configuration of the user terminal;

FIG. 4 illustrates an example of print data to be displayed on a display of the user terminal;

FIG. 5 is a flowchart illustrating a procedure of information processing executed by the user terminal of the first exemplary embodiment;

FIG. 6 illustrates an example of print data to be displayed on a display of the user terminal of a second exemplary embodiment;

FIG. 7 is a block diagram illustrating an example of the functional configuration of a user terminal of a third exemplary embodiment;

FIG. 8A illustrates an example of print data to be displayed on a display of the user terminal of the third exemplary embodiment;

FIG. 8B illustrates an example of print data after background processing for replacing only the background of a character string by a spot color is performed; and

FIG. 9 is a flowchart illustrating a procedure of information processing executed by the user terminal of the third exemplary embodiment.

### DETAILED DESCRIPTION

Exemplary embodiments of the disclosure will be described below with reference to the accompanying drawings. In the individual drawings, identical or equivalent elements or portions are designated by like reference numeral. For the sake of representation, the dimensional ratios in the drawings are exaggerated and may be different from the actual ratios.

### First Exemplary Embodiment

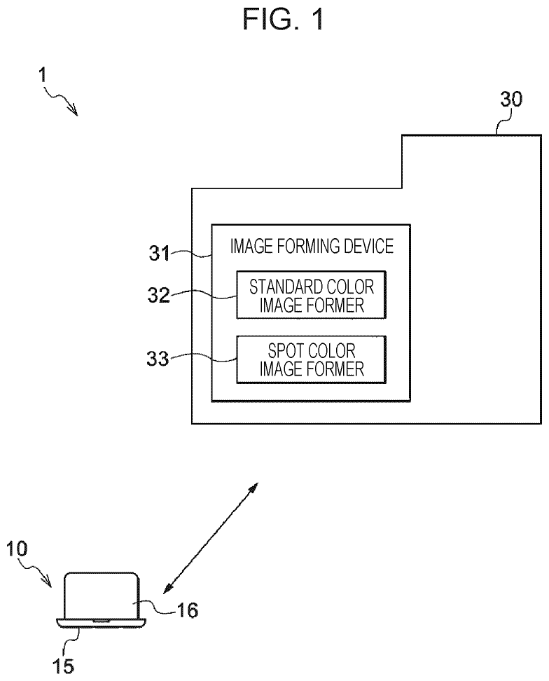

FIG. 1 is a schematic diagram of an information processing system including a user terminal of a first exemplary embodiment.

As illustrated in FIG. 1, an information processing system 1 includes a user terminal 10, which is an example of an information processing device, and a printer 30, which is an example of an image forming apparatus. In the information processing system 1, the user terminal 10 and the printer 30 connect to each other via the internet or a wired or a wireless network. In one example, in the information processing system 1 shown in FIG. 1, the user terminal 10 and the printer 30 connect to each other via a wireless network.

The user terminal 10 is a device that creates print data and provides a print instruction, for example. In one example, the user terminal 10 provides a print instruction by sending a print job including print data to the printer 30.

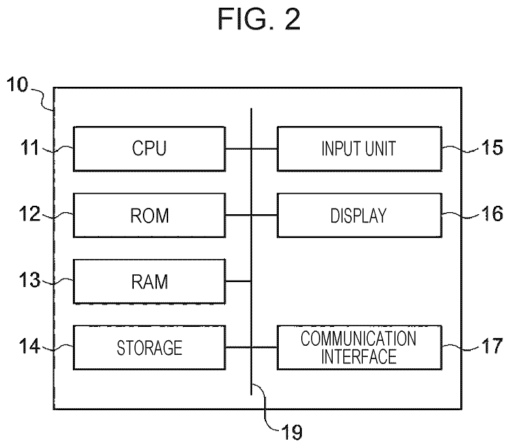

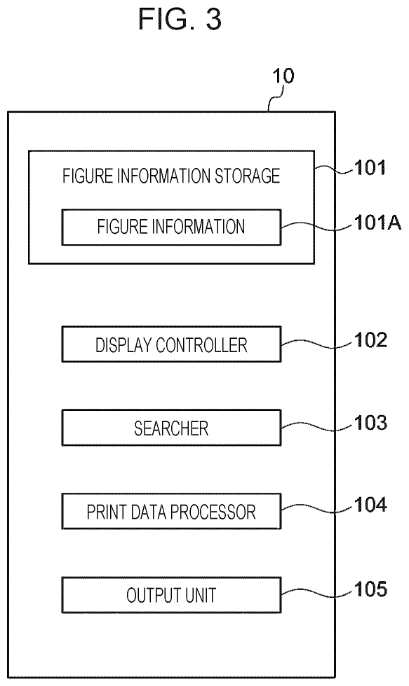

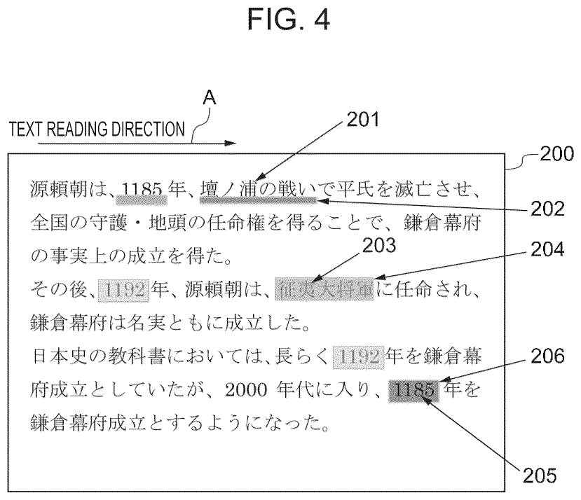

In a storage 14 (see FIG. 2) of the user terminal 10, figure information 101A (see FIG. 3), which is information to be expressed by a line marker for highlighting information to be output as text, is stored. The figure information 101A includes information of a figure having a width extending in a direction intersecting with a reading direction of text to be drawn in print data 200. In the first exemplary embodiment, examples of a figure having a width extending in a direction intersecting with a text reading direction is a figure disposed along the text reading direction (direction indicated by the arrow A in FIG. 4) and configured by a quadrilateral defined by two line segments parallel with each other. Specific examples of such a figure are figures 202, 204, and 206 shown in FIG. 4.

If the print data 200 indicates that the figures 202, 204, and 206 configured by such quadrilaterals are each disposed along the text reading direction (direction indicated by the arrow A in FIG. 4) so as to be superimposed on at least part of the text and are also each drawn with a color corresponding to a predetermined color, the user terminal 10 replaces the color of each of the figures 202, 204, and 206 by a spot color. Processing for replacing the color of each of the figures 202, 204, and 206 by a spot color will be discussed later.

The user terminal 10 includes an input unit 15 and a display 16 (see FIG. 2). The display 16 displays print data, for example. With the input unit 15, print data is created and a print instruction is provided, for example.

The printer 30 is an apparatus that performs printing on a recording medium in accordance with a print instruction received from the user terminal 10. The printer 30 receives a print job including print data from the user terminal 10 and forms an image corresponding to the print data on a recording medium.

The printer 30 includes an image forming device 31. The image forming device 31 includes a standard color image former 32 and a spot color image former 33. The standard color image former 32 forms an image by using four standard colors, namely, cyan, magenta, yellow, and black. The printer 30 drives the image forming device 31 to form an image corresponding to print data on a recording medium. The spot color image former 33 forms an image by using a spot color. The spot color is a specially created color, which is other than cyan, magenta, yellow, and black. Examples of the spot color are gold, silver, and fluorescent colors. The printer 30 is able to form an image with one or more spot colors by using the spot color image former 33. If a spot color can be expressed by the four standard colors, namely, cyan, magenta, yellow, and black, an image may be formed by such standard colors using predetermined color components.

In one example, the printer 30 forms an image corresponding to print data on a recording medium according to an electrophotographic system. The printer 30 includes an image forming unit as the image forming device 31. In this case, the standard color image former 32 forms standard color toner images, while the spot color image former 33 forms spot color toner images. The printer 30 also includes a transfer unit that transfers a toner image to a recording medium and a fixing unit that fixes a toner image transferred to a recording medium on the recording medium. The printer 30 may form an image corresponding to print data on a recording medium according to an inkjet system instead of the electrophotographic system.

FIG. 2 is a block diagram of the hardware configuration of the user terminal 10.

As illustrated in FIG. 2, the user terminal 10 includes a central processing unit (CPU) 11, a read only memory (ROM) 12, a random access memory (RAM) 13, a storage 14, an input unit 15, a display 16, and a communication interface 17. These elements are connected to each other via a bus 19 so that they can communicate with each other.

The CPU 11 executes various programs and controls the individual elements of the user terminal 10. The CPU 11 is an example of a processor. That is, the CPU 11 reads a program from the ROM 12 or the storage 14 and executes the program by using the RAM 13 as a work area. The CPU 11 controls the elements of the user terminal 10 and executes computing operations in accordance with programs stored in the ROM 12 or the storage 14. In the exemplary embodiments of the disclosure, an information processing program is stored in the ROM 12 or the storage 14.

In the ROM 12, various programs and various items of data are stored. The RAM 13 is used as a work area for temporarily storing a program or data. The storage 14 is constituted by a hard disk drive (HDD) or a solid state drive (SSD), and stores various programs including an operating system (OS) and various items of data. In the storage 14, a printer driver program is stored. The CPU 11 reads the printer driver program from the storage 14 and executes it so as to function as a printer driver. The RAM 13 and the storage 14 are examples of a memory.

The display 16 is a liquid crystal display, for example, and displays various types of information. The input unit 15 includes a pointing device, such as a mouse, and a keyboard, and is used for various input operations. The input unit 15 may alternatively form part of a touchscreen.

The communication interface 17 is used for communicating with other devices, such as the printer 30. Ethernet (registered trademark), fiber distributed data interface (FDDI), or Wi-Fi (registered trademark), for example, is used as the standard of the communication interface 17.

FIG. 3 is a block diagram illustrating an example of the functional configuration of the user terminal 10.

As illustrated in FIG. 3, the user terminal 10 includes a figure information storage 101, a display controller 102, a searcher 103, a print data processor 104, and an output unit 105 as functional modules. These functional modules are implemented as a result of the CPU 11 reading an information processing program stored in the ROM 12 or the storage 14, loading it to the RAM 13, and executing it.

The figure information storage 101 has a function of storing the above-described figure information 101A, which is information to be expressed by a line marker for highlighting information to be output as text. As shown in FIG. 4, an example of a figure indicated by the figure information 101A is a figure disposed along the reading direction (direction indicated by the arrow A) of text to be drawn in the print data 200 and configured by a quadrilateral defined by two line segments parallel with each other (such as figures 202, 204, and 206 shown in FIG. 4). The figure information storage 101 is constituted by the storage 14, for example.

The display controller 102 has a function of controlling a screen to be displayed on the display 16. The display controller 102 displays the print data 200 (see FIG. 4), for example, on the display 16.

The searcher 103 has a function of searching for a figure which is disposed along a reading direction of text to be drawn and which is configured by a quadrilateral defined by two line segments parallel with each other, based on the figure information 101A. The function of the searcher 103 will be specifically explained below with reference to FIG. 4.

FIG. 4 illustrates an example of the print data 200 to be displayed on the display 16. As illustrated in FIG. 4, the print data 200 indicates the figures 202, 204, and 206, which are each disposed along the text reading direction (direction indicated by the arrow A) and configured by a quadrilateral defined by two line segments parallel with each other. The figure 202 is disposed along the text reading direction so as to be superimposed on the bottom portion of a character string 201. The figure 202 is an underline marker superimposed on the bottom portion of the character string 201. The figure 204 is disposed along the text reading direction so as to be superimposed on the entire front surface of a character string 203. The figure 204 is a translucent line marker superimposed on the entire front surface of the character string 203. The figure 206 is disposed along the text reading direction so as to be superimposed on the entire back surface of a character string 205. The figure 206 is a background line marker superimposed on the entire back surface of the character string 205.

Based on the figure information 101A, the searcher 103 searches the print data 200 for a figure disposed along a reading direction (direction indicated by the arrow A) of text to be drawn (such as the figures 202, 204, and 206) and configured by a quadrilateral defined by two line segments parallel with each other. For example, when the print data processor 104 of the user terminal 10 reads the print data 200, text data and figure data are sequentially supplied in the text reading direction. In the case of an underline marker and a translucent line marker, text data is first supplied, and then, figure data is supplied. Conversely, in the case of a background line marker, figure data is first supplied, and then, text data is supplied. This enables the searcher 103 to recognize the reading direction (direction indicated by the arrow A) of text to be drawn in the print data 200. The searcher 103 is thus able to search for a figure disposed along the text reading direction (direction indicated by the arrow A) and configured by a quadrilateral defined by two line segments parallel with each other (such as the figures 202, 204, and 206).

The print data processor 104 has a function of processing print data. If a figure searched by the searcher 103 (such as the figures 202, 204, and 206 in FIG. 4) is disposed along the text reading direction (direction indicated by the arrow A) so as to be superimposed on at least part of text (character string) and is drawn with a color corresponding to a predetermined color, the print data processor 104 replaces this color by a spot color. “The predetermined color” is a color expressed by any of spot colors that can be printed by the printer 30. If the figures 202, 204, and 206 searched by the searcher 103 are each disposed along the text reading direction (direction indicated by the arrow A) so as to be superimposed on at least part of the corresponding character string, it is highly probable that they are figures expressed by line markers. The print data processor 104 thus regards the figures 202, 204, and 206 as those expressed by line markers for highlighting information to be output as text and executes processing to print the figures 202, 204, and 206 using spot colors.

If the color of a figure (such as figures 202, 204, and 206) is not a color expressed by any of spot colors that can be printed by the printer 30, the print data processor 104 determines that the color of this figure is to be maintained as another predetermined color. “Maintaining as another predetermined color means that the figure is to be printed with the corresponding standard colors.

If a figure disposed along a reading direction of text to be drawn and configured by a quadrilateral defined by two line segments parallel with each other is not superimposed on even at least part of text (character string), the print data processor 104 determines that this figure is to be printed by using the corresponding standard colors and outputs print data reflecting the color of the figure.

The output unit 105 has a function of outputting print data to the printer 30. In one example, the output unit 105 outputs a print job including print data to the printer 30. The print data is data processed by the print data processor 104. As a result, the printer 30 can form an image corresponding to the print data on a recording medium.

The operation of the user terminal 10 of the first exemplary embodiment will now be discussed below.

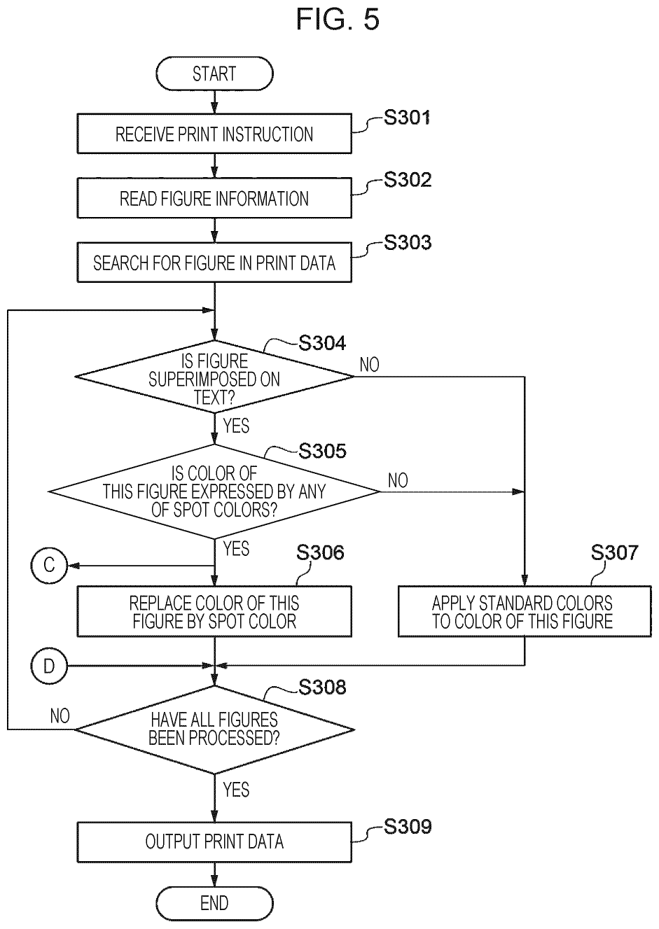

FIG. 5 is a flowchart illustrating a procedure of information processing executed by the user terminal 10. The information processing can be executed as a result of the CPU 11 reading an information processing program from the ROM 12 or the storage 14, loading it to the RAM 13, and executing it.

Prior to the execution of the information processing shown in FIG. 5, a user first creates or reads the print data 200 (see FIG. 4) in the user terminal 10. The information processing in FIG. 5 is executed when the user wants to print the print data 200 by using the printer 30, that is, to form an image corresponding to the print data 200 on a recording medium. The user selects the print data 200 and inputs print settings and a print instruction by using the input unit 15 of the user terminal 10.

In response to the user selecting the print data 200 and inputting the print settings and print instruction, the CPU 11 receives this print instruction in step S301. In one example, in response to receiving the print instruction of the print data 200, the CPU 11 creates a print job for causing the printer 30 to print the print data 200. The print job includes the print data 200 and print setting information, for example. The print setting information indicates a color setting for each page, positional relationships between text and figures, the superimposition states of text and figures, and postprocessing, for example.

In step S302, the CPU 11 reads the figure information 101A. The figure information 101A includes information on a figure which is disposed along the reading direction of text to be drawn in the print data 200 and which is configured by a quadrilateral defined by two line segments parallel with each other. The figure information 101A is stored in the storage 14, for example.

In step S303, based on the figure information 101A, the CPU 11 searches for a figure in the print data 200, that is, a figure disposed along the reading direction of text and configured by a quadrilateral defined by two line segments parallel with each other. As a result, the figures 202, 204, and 206 (see FIG. 4), which are disposed along the reading direction (direction indicated by the arrow A) of text to be drawn in the print data 200 and which are each configured by a quadrilateral defined by two line segments parallel with each other, are found.

In step S304, the CPU 11 judges whether a figure among the searched figures is superimposed on text (character string). For example, the CPU 11 judges whether a selected one of the searched figures 202, 204, and 206 is superimposed on text (character string). If the selected figure is superimposed on the entirety or part of the text, the CPU 11 determines that this figure is superimposed on the text. For example, if a selected figure is superimposed on the entirety or part of the text, it is highly probable that this figure is expressed by a line marker for highlighting information to be output as text. In the first exemplary embodiment, if all the figures 202, 204, and 206 are superimposed on the entirety or part of the corresponding character strings and if spot color printing, which will be discussed later, is feasible, the CPU 11 regards the figures 202, 204, and 206 as those expressed by line markers for highlighting information to be output as text and executes processing to print the figures 202, 204, and 206 by using spot colors.

If the selected figure is superimposed on the text (YES in step S304), the CPU 11 judges in step S305 whether the color of this figure is a color expressed by any of spot colors. If the color of a selected one of the figures 202, 204, and 206 is a color expressed by any of spot colors that can be printed by the printer 30, the CPU 11 determines that the color of the selected figure is a color expressed by any of spot colors.

If the color of the selected figure is expressed by any of spot colors (YES in step S305), the CPU 11 replaces the color of the selected figure by the corresponding spot color in step S306. For example, the CPU 11 replaces the color of a selected one of the figures 202, 204, and 206 in the print data 200 by the corresponding spot color. In the case of the FIG. 202, for example, the color of the figure 202 superimposed on the bottom portion of the character string 201 is replaced by the corresponding spot color in accordance with the print setting information, thereby making it possible to perform spot color printing for the underline marker. In the case of the figure 204, for example, the color of the figure 204 superimposed on the front surface of the character string 203 is replaced by the corresponding spot color in accordance with the print setting information, thereby making it possible to perform spot color printing for the translucent line marker. In the case of the figure 206, for example, the color of the figure 206 superimposed on the back surface of the character string 205 is replaced by the corresponding spot color in accordance with the print setting information, thereby making it possible to perform spot color printing for the background line marker.

If the figure is not superimposed on text (NO in step S304), the CPU 11 applies the corresponding standard colors which are indicated in the print settings to the color of this figure in step S307. For example, if the selected figure is not superimposed on text, it is highly probable that this figure is a figure other than a line marker or is a ruled line. In this case, the CPU 11 does not replace the color of this figure by a spot color.

If the color of the selected figure is not a color expressed by any of spot colors (NO in step S305), the CPU 11 applies the corresponding standard colors which are indicated in the print settings to the color of this figure in step S307.

The CPU 11 judges in step S308 whether all the figures have been processed. For example, the CPU 11 judges whether all the searched figures (such as those including the figures 202, 204, and 206) in the print data 200 have been processed.

If not all the figures have been processed (NO in step S308), the CPU 11 returns to step S304.

If all the figures have been processed (YES in step S308), the CPU 11 outputs the print data to the printer 30 in step S309. In one example, the CPU 11 outputs a print job including the print data and print settings to the printer 30. As a result of the printer 30 executing the print job, an image corresponding to the print data is formed on a recording medium. Then, the information processing executed by the user terminal 10 based on the information processing program has been completed.

By using the user terminal 10 and the information processing program, even for image data to which a form is not applicable, it is possible to perform spot color printing without registering a form.

For example, to perform spot color printing, a form in which a region to be printed with a spot color is specified may be registered in advance. In this approach, however, it is necessary to prepare a form. For print data to which a form is not applicable, it is necessary to register a form every time spot color printing is performed. In another example, an instruction to replace RGB colors (red, green, and blue) by a spot color may be provided to a printer. In this approach, however, if RGB colors are included in another region, this region may be printed with a spot color unintentionally.

In contrast, in the user terminal 10 of the first exemplary embodiment, even for image data to which a form is not applicable, it is possible to perform spot color printing without registering a form. Additionally, it is less likely to inadvertently print a region other than a region intended to be printed with a spot color, compared with the configuration in which RGB colors are replaced by a spot color in a printer.

In the user terminal 10, a figure whose color is to be replaced by a spot color is a figure disposed along a text reading direction and configured by a quadrilateral defined by two line segments parallel with each other (such as figures 202, 204, and 206 in FIG. 4). This makes it less likely to print a figure with a spot color by mistake, compared with when a figure defined by two line segments tilting with respect to a text reading direction is set as a figure whose color is to be replaced by a spot color.

In the user terminal 10, if a figure is not superimposed even on part of text, the CPU 11 sets the color of this figure to be the corresponding standard colors, which are not a spot color, and outputs print data reflecting the color of this figure. As a result, this figure is printed with the corresponding standard color.

In the user terminal 10, if the color of a figure is not a color expressed by any of spot colors that can be printed, the CPU 11 maintains the color of the figure as another predetermined color and outputs print data reflecting the color of the figure. The figure can thus be printed with the corresponding standard colors as indicated in the print settings.

### Second Exemplary Embodiment

A user terminal according to a second exemplary embodiment will now be described below. The same element or the same portion as that in the first exemplary embodiment is designated by like reference numeral and an explanation thereof will be omitted.

As in the first exemplary embodiment shown in FIG. 3, a user terminal 10 of the second exemplary embodiment includes a figure information storage 101, a display controller 102, a searcher 103, a print data processor 104, and an output unit 105. However, the figure information 101A stored in the figure information storage 101 indicates an additional figure, and the searcher 103 searches for such an additional figure, based on the figure information 101A.

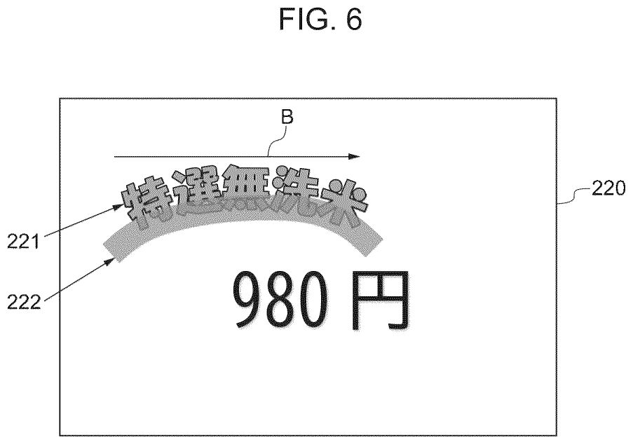

The figure information 101A includes information on an additional figure, as well as information on the figures indicated by the figure information 101A in the first exemplary embodiment. FIG. 6 illustrates print data 220, which is an example of print data to be displayed on the display 16. As illustrated in FIG. 6, the print data 220 indicates a FIG. 222 disposed along a reading direction (direction indicated by the arrow B) of text to be drawn and defined by two curved line segments parallel with each other. The figure information 101A also includes information on such a figure (FIG. 222). The FIG. 222 is an example of a figure having a width extending in a direction intersecting with a text reading direction. The FIG. 222, which is a translucent figure, is superimposed on the bottom portion of a character string 221. For example, the two curved parallel line segment vectors of the FIG. 222 are substantially horizontal along the reading direction (direction indicated by the arrow B) of the character string 221.

Based on the figure information 101A, the searcher 103 searches the print data 220 for the FIG. 222, which is disposed along the reading direction (direction indicated by the arrow B) of text to be drawn and is defined by two curved line segments parallel with each other.

If the FIG. 222 is disposed along the text reading direction so as to be superimposed on at least part of the character string 221, as illustrated in FIG. 6, and if the FIG. 222 is drawn with a color corresponding to a predetermined color, the print data processor 104 replaces the color of the FIG. 222 by a spot color.

The procedure of information processing executed by the user terminal 10 of the second exemplary embodiment is similar to that indicated by the flowchart in FIG. 5.

### Third Exemplary Embodiment

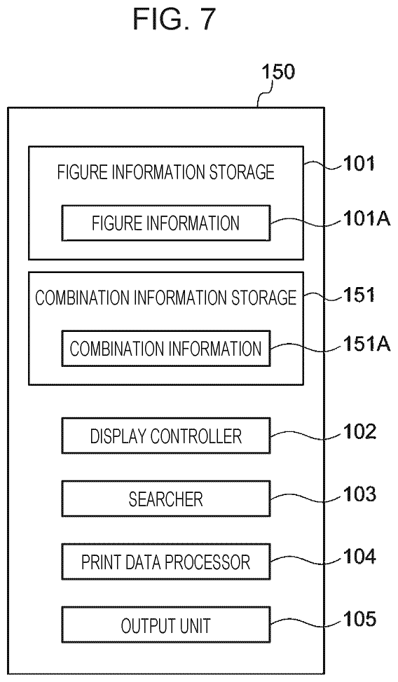

A user terminal 150 according to a third exemplary embodiment will now be described below with reference to FIGS. 7 through 9. The same element or the same portion as that in the first and second exemplary embodiments is designated by like reference numeral and an explanation thereof will be omitted.

The hardware configuration of the user terminal 150 of the third exemplary embodiment is similar to that of the user terminal 10 of the first exemplary embodiment. The functional configuration of the user terminal 150 is different from that of the user terminal 10.

FIG. 7 is a block diagram illustrating an example of the functional configuration of the user terminal 150 of the third exemplary embodiment. As illustrated in FIG. 7, the user terminal 150 includes a combination information storage 151 in addition to the elements of the user terminal 10 of the first exemplary embodiment.

In the combination information storage 151, combination information 151A is stored. The combination information 151A is information on a combination of text (characters) and a figure which makes it difficult to read the text when a specified color of the figure is superimposed on the color of the text. More specifically, the combination information 151A is information on a combination of a color of characters and a specified color of a figure which makes it difficult to read the characters when the specified color of the figure is superimposed on the color of the characters. The specified color is a color expressed by a spot color other than the standard colors. The combination information 151A is stored in the storage 14, for example.

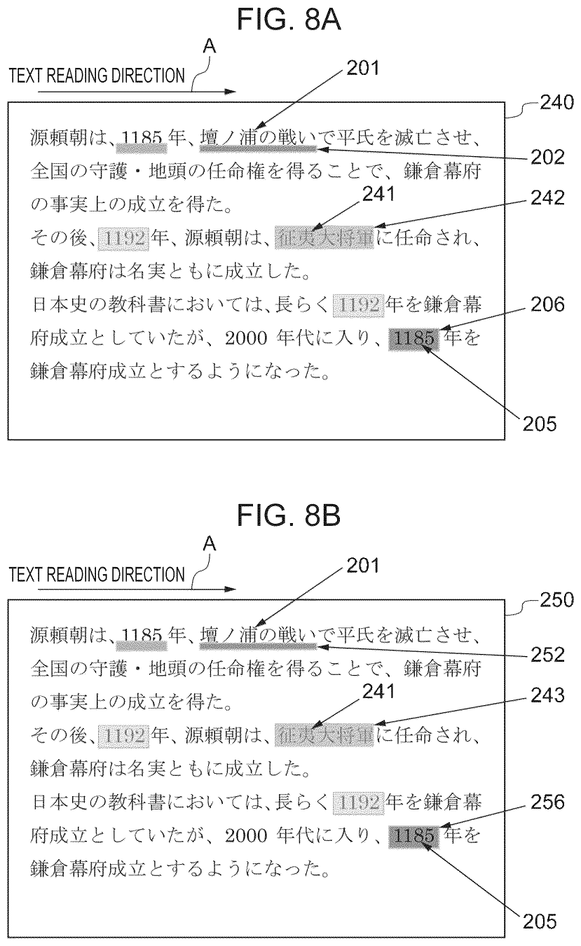

FIG. 8A illustrates an example of a combination of a character string, which is an example of text, and a figure which makes it difficult to read the character string when the color of the figure is superimposed on the color of the character string. More specifically, FIG. 8A illustrates a combination of a character string 241 and a FIG. 242 in print data 240, which makes it difficult to read the character string 241 when the color of the FIG. 242 is superimposed on the color of the character string 241. The color of the character string 241 is black, for example, while the color of the FIG. 242 is gold, for example. The FIG. 242 is a translucent line marker, and the gold color of the FIG. 242 is superimposed on the color of the character string 241, that is, on the front surface of the character string 241, by means of translucent composition. For example, when a gold toner forming the FIG. 242 is superimposed on the color of the character string 241 with a predetermined pattern (50% pattern, for example), the character string 241 becomes difficult to read.

If a figure superimposed on the color of the character string 241, that is, on the surface of the character string 241, is a translucent figure, such as the FIG. 242, the print data processor 104 executes background processing for the character string 241 and the FIG. 242 in accordance with a combination of the color of the FIG. 242 and that of the character string 241. Background processing is processing for converting the FIG. 242 to a FIG. 243 by replacing only the color of the background of the character string 241 by a spot color while maintaining the color of the character string 241, as illustrated in FIG. 8B. That is, as a result of executing background processing, the print data processor 104 outputs print data 250 indicating that the FIG. 243, which corresponds to the background of the character string 241 whose color is replaced by a spot color (gold, for example), is to be printed, while the character string 241 is to be printed by maintaining its color (black, for example). The print data processor 104 executes this background processing if text, such as the character string 241, becomes difficult to read when the color of a figure, such as the FIG. 242, is superimposed on the character string 241.

The operation of the user terminal 150 of the third exemplary embodiment will now be discussed below.

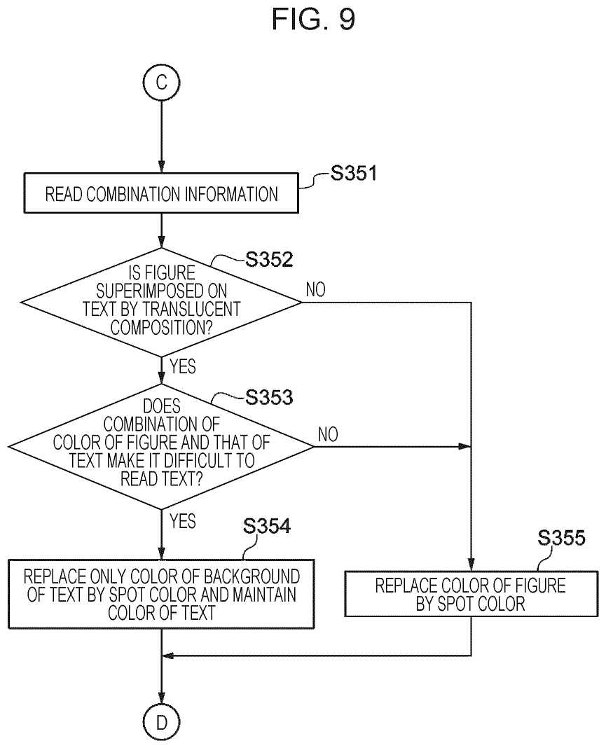

FIGS. 5 and 9 are a flowchart illustrating a procedure of information processing executed by the user terminal 150. The information processing can be executed as a result of the CPU 11 reading an information processing program from the ROM 12 or the storage 14, loading it to the RAM 13, and executing it.

As illustrated in FIG. 5, steps S301 through S305 of the information processing executed by the user terminal 150 are similar to those of information processing executed by the user terminal 10 of the first exemplary embodiment.

After step S305, in step S351 in FIG. 9, the CPU 11 reads the combination information 151A. The combination information 151A includes information on a combination of text and a figure, such as the character string 241 and the FIG. 242, which makes it difficult to read the character string 241 when the gold color of the FIG. 242 is superimposed on the black color of the character string 241, as illustrated in FIG. 8A.

In step S352, the CPU 11 judges whether the figure is superimposed on text (character string) by means of translucent composition. Translucent composition is to, for example, superimpose a specified color of the FIG. 242 on the front surface of the character string 241, as illustrated in FIG. 8A.

If the figure is superimposed on the text by means of translucent composition (YES in step S352), the CPU 11 judges in step S353 based on the combination information 151A whether the combination of the color of the figure and that of the text (character string) makes it difficult to read the text. If, for example, the gold color of the FIG. 242 is superimposed on the black color of the character string 241 (that is, on the front surface of the character string 241), as illustrated in FIG. 8A, the CPU 11 determines that the character string 241 is difficult to read.

If the combination of the color of the figure and that of the text (character string) makes it difficult to read the text (YES in step S353), the CPU 11 executes processing for replacing only the color of the background of the text by a spot color while maintaining the color of the text in step S354. For example, the CPU 11 converts the FIG. 242 to the FIG. 243 by replacing only the color of the background of the character string 241 by a spot color, which is gold, while maintaining the color of the character string 241 to be black so as to generate print data 250, as illustrated in FIG. 8B.

If the figure is not superimposed on the text (character string) by means of translucent composition (NO in step S352), the CPU 11 replaces the color of the figure by a spot color in step S355. For example, the CPU 11 generates a FIG. 256 by replacing the color of the figure 206, which is not a translucent figure, by a spot color, as illustrated in FIG. 8B. The FIG. 256 is a background line marker to be printed on the back surface of the character string 205. Hence, the character string 205 does not become difficult to read even if the color of the FIG. 256 is replaced by a spot color. Likewise, the CPU 11 generates a FIG. 252 by replacing the color of the figure 202, which is not a translucent figure, by a spot color. The FIG. 252 is an underline marker to be printed on the bottom portion of the character string 201. Hence, the character string 201 does not become difficult to read even if the color of the FIG. 252 is replaced by a spot color.

If the combination of the color of the figure and that of the text does not make it difficult to read the text (NO in step S353), the CPU 11 replaces the color of the figure by a spot color in step S355. That is, even when the figure is superimposed on the text by means of translucent composition, if the text does not become difficult to read, the CPU 11 replaces the color of the figure by a spot color.

Then, the CPU 11 executes steps S308 and S309 in FIG. 5.

The user terminal 150 of the third exemplary embodiment is configured in the following manner.

In the user terminal 150 of the third exemplary embodiment, if the FIG. 242 superimposed on at least part of the character string 241 is a translucent figure, the CPU 11 executes background processing for converting the FIG. 242 to the FIG. 243 by replacing only the color of the background of the character string 241 by a spot color while maintaining the color of the character string 241 in accordance with a combination of the specified color of the FIG. 242 and the color of the character string 241. It is thus less likely that the FIG. 243 makes the character string 241 difficult to read, compared with the configuration in which printing is unconditionally performed by superimposing a translucent figure on a character string.

In the user terminal 150 of the third exemplary embodiment, the combination information 151A is stored in the storage 14. If the combination information 151A indicates that the combination of the specified color of the FIG. 242 and the color of the character string 241 is a combination that makes it difficult to read the character string 241, the CPU 11 executes background processing for converting the FIG. 242 to the FIG. 243 by replacing only the color of the background of the character string 241 by a spot color while maintaining the color of the character string 241. It is thus less likely that the FIG. 243 makes the character string 241 difficult to read, compared with the configuration in which printing is unconditionally performed by disregarding the above-described combination of a character string and a figure.

### [Others]

In the above-described first through third exemplary embodiments, the user terminal 10 or 150 and the printer 30 connect to each other via a wireless medium. However, the disclosure is not restricted to this configuration. For example, the user terminal 10 or 150 and the printer 30 may connect to each other via a wired medium. Alternatively, the user terminal 10 or 150 and the printer 30 may wirelessly connect to each other via a repeater, such as a server.

In the above-described first through third exemplary embodiments, the user terminal 10 or 150 and the printer 30 are separate devices. However, the disclosure is not restricted to this configuration. For example, the printer 30 may integrate the user terminal 10 or 150. In one example, the printer 30 may be formed as an image forming apparatus including: the user terminal 10 or 150 formed as an information processing device including a processor; and an image forming device that forms an image on a recording medium based on print data output from the information processing device.

In the above-described first through third exemplary embodiments, any figure having a width extending in a direction intersecting with a reading direction of text to be drawn in print data may be replaced by or added to figures indicated by the figure information 101A. In the first and third exemplary embodiments, the above-described figure is a figure disposed along a text reading direction and configured by a quadrilateral defined by two line segments parallel with each other. The two line segments may not necessarily be line segments completely parallel with each other and may be line segments substantially parallel with each other. In the second exemplary embodiment, the above-described figure is a figure disposed along a text reading direction and defined by two curved line segments parallel with each other. The two curved line segments may not necessarily be line segments completely parallel with each other and may be line segments substantially parallel with each other.

The above-described processing executed by the user terminal 10 or 150 and the printer 30 may be implemented by a dedicated hardware circuit. In this case, a single hardware unit may be used or plural hardware units may be used.

A program for operating the user terminal 10 or 150 and the printer 30 may be provided as a result of being recorded on a computer readable recording medium, such as a universal serial bus (USB) memory, a flexible disk, and a compact disc-read only memory (CD-ROM), or may be provided online via a network, such as the internet. The program recorded on a computer readable recording medium is typically transferred to a memory or a storage, for example, and is stored. The program may be provided as application software or be integrated into software of the user terminal 10 or 150 and that of the printer 30 as one function of such devices.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing device comprising:
at least one processor configured to:
   replace, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and
   output the print data reflecting the color of the figure replaced by the spot color.
      (((2)))

The information processing device according to (((1))), wherein the figure has a quadrilateral shape defined by two line segments disposed along the reading direction.

(((3)))

The information processing device according to (((1))), wherein the figure has a quadrilateral shape defined by two curved line segments disposed along the reading direction.

(((4)))

The information processing device according to one of (((1))) to (((3))), wherein the at least one processor is configured to set the color of the figure to be a preset standard color, which is not a spot color, and to output the print data reflecting the color of the figure set to the preset standard color if the figure is not superimposed even on at least part of the text.

(((5)))

The information processing device according to one of (((1))) to (((4))), wherein the at least one processor is configured to maintain the color of the figure as a second predetermined color and to output the print data reflecting the color of the figure maintained as the second predetermined color if the color of the figure is not a color expressed by a spot color which is able to be printed.

(((6)))

The information processing device according to one of (((1))) to (((5))), wherein the at least one processor is configured to execute background processing if the figure is a translucent figure superimposed on at least part of the text, the background processing being processing for replacing only a color of a background of the text on which the translucent figure is superimposed by a spot color while maintaining a color of a character portion of the text in accordance with a combination of a specified color of the figure and the color of the character portion of the text.

(((7)))

The information processing device according to (((6))), further comprising:
a memory,
wherein information on a combination of a specified color of a figure and a color of a character portion of text which makes it difficult to read the character portion when the specified color of the figure is superimposed on the color of the character portion is prestored in the memory, and
wherein the at least one processor is configured to execute the background processing if the at least one processor determines, based on the information prestored in the memory, that the specified color of the translucent figure and the color of the character portion of the text is a combination which makes it difficult to read the character portion.
   (((8)))

An image forming apparatus comprising:
the information processing device according to one of (((1))) to (((7))); and
an image forming device that forms an image on a recording medium based on print data output from the information processing device.
   (((9)))

An information processing program for causing a computer to execute a process, the process comprising:
replacing, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and
outputting the print data reflecting the color of the figure replaced by the spot color.

What is claimed is:

1. An information processing device comprising:
at least one processor configured to:
replace, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and
output the print data reflecting the color of the figure replaced by the spot color.

2. The information processing device according to claim 1, wherein the figure has a quadrilateral shape defined by two line segments disposed along the reading direction.

3. The information processing device according to claim 1, wherein the figure has a quadrilateral shape defined by two curved line segments disposed along the reading direction.

4. The information processing device according to claim 1, wherein the at least one processor is configured to set the color of the figure to be a preset standard color, which is not a spot color, and to output the print data reflecting the color of the figure set to the preset standard color if the figure is not superimposed even on at least part of the text.

5. The information processing device according to claim 1, wherein the at least one processor is configured to maintain the color of the figure as a second predetermined color and to output the print data reflecting the color of the figure maintained as the second predetermined color if the color of the figure is not a color expressed by a spot color which is able to be printed.

6. The information processing device according to claim 1, wherein the at least one processor is configured to execute background processing if the figure is a translucent figure superimposed on at least part of the text, the background processing being processing for replacing only a color of a background of the text on which the translucent figure is superimposed by a spot color while maintaining a color of a character portion of the text in accordance with a combination of a specified color of the figure and the color of the character portion of the text.

7. The information processing device according to claim 6, further comprising:
a memory,
wherein information on a combination of a specified color of a figure and a color of a character portion of text which makes it difficult to read the character portion when the specified color of the figure is superimposed on the color of the character portion is prestored in the memory, and
wherein the at least one processor is configured to execute the background processing if the at least one processor determines, based on the information prestored in the memory, that the specified color of the translucent figure and the color of the character portion of the text is a combination which makes it difficult to read the character portion.

8. An image forming apparatus comprising:
the information processing device according to claim 1; and
an image forming device that forms an image on a recording medium based on print data output from the information processing device.

9. An image forming apparatus comprising:
the information processing device according to claim 2; and
an image forming device that forms an image on a recording medium based on print data output from the information processing device.

10. An image forming apparatus comprising:
the information processing device according to claim 3; and
an image forming device that forms an image on a recording medium based on print data output from the information processing device.

11. An image forming apparatus comprising:
the information processing device according to claim 4; and
an image forming device that forms an image on a recording medium based on print data output from the information processing device.

12. An image forming apparatus comprising:
the information processing device according to claim 5; and
an image forming device that forms an image on a recording medium based on print data output from the information processing device.

13. An image forming apparatus comprising:
the information processing device according to claim 6; and
an image forming device that forms an image on a recording medium based on print data output from the information processing device.

14. An image forming apparatus comprising:
the information processing device according to claim 7; and
an image forming device that forms an image on a recording medium based on print data output from the information processing device.

15. An information processing method comprising:
replacing, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and
outputting the print data reflecting the color of the figure replaced by the spot color.

16. A non-transitory computer readable medium storing a program causing a computer to execute a process, the process comprising:
replacing, if print data indicates that a figure which has a width extending in a direction intersecting with a reading direction of text to be drawn and which is disposed along the reading direction is superimposed on at least part of the text and if the figure is drawn with a color corresponding to a first predetermined color, the color of the figure by a spot color; and
outputting the print data reflecting the color of the figure replaced by the spot color.
